(19) United States
(12) Patent Application Publication
(10) Pub. No.: US 2007/0048055 A1
(43) Pub. Date: Mar. 1, 2007

(54) IMAGE FORMING APPARATUS

(75) Inventor: Takemasa ISHIKURO, Minato-ku, Tokyo (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: OKI DATA CORPORATION

(21) Appl. No.: 11/460,259

(22) Filed: Jul. 27, 2006

(30) Foreign Application Priority Data
Aug. 23, 2005 (JP) 2005-241209

(51) Int. Cl. G03G 15/00

(52) U.S. Cl. 399/405

(57) ABSTRACT

An image forming apparatus capable of properly discharging a medium has a first medium stacking unit, a second medium stacking unit, and a guiding member for guiding the medium to the second medium stacking unit in a case that the second medium stacking unit is set in an opened state and guiding the medium to the first medium stacking unit in a case that the second medium stacking unit is set in a closed state. Since the guiding member guides the medium to the second medium stacking unit in a case that the second medium stacking unit is set in the opened state and guides medium to the first medium stacking unit in a case that the second medium stacking unit is set in the closed state, the medium can be discharged to the second medium stacking unit in a case that large normal curling occurs.

### BACKGROUND OF THE INVENTION

This invention relates to an image forming apparatus.

Conventionally, an imaging forming apparatus such as, e.g., a printer, a photocopier, a facsimile machine, and a multi-functional machine, for example, an electrophotographic printer includes a paper feed mechanism for feeding paper as a medium, an image forming unit for forming a toner image, a fuser for fusing the toner image, a discharging mechanism for discharging the paper, and the like. The discharging mechanism is composed of a face down discharging unit composing a first discharging unit to which printed paper is discharged with a printed side down, and a face up discharging unit composing a second discharging unit capable of discharging various sorts of paper, performing post processing such as, e.g., sorting operation and punching operation and discharging the paper with the printed side up. The paper can be selectively discharged to either the face down discharging unit or the face up discharging unit, by an operator's switching a discharging route. (see, e.g., Japanese Unexamined Patent Publication No. 2000-267544)

With such a conventional electrophotographic printer, however, such paper as moved through the fuser gets curled, i.e., deformed, in a crescent shape, not only because the paper receives heat from a printing side at the time when a toner image is fused but also because a toner is fused on the printing side. There are two types of curling, normal curling, i.e., a concave curling, and reverse curling. For example, in a case of occurrence of large normal curling, even where paper is to be discharged to the face up discharging unit, the paper with large normal curling undesirably goes into the face down discharging unit. As the result, paper jamming occurs, and the paper cannot be discharged properly.

### BRIEF SUMMARY OF THE INVENTION

It is an object of this invention to solve the problems in conventional printers described above and further to provide an image forming apparatus capable of properly discharging the medium.

To achieve the above, an image forming apparatus according to this invention has a first medium stacking unit for stacking the medium, a second medium stacking unit capable of being opened and closed with respect to an apparatus body for stacking the medium, and a guiding member arranged swingably on the apparatus body for leading the medium to the second medium stacking unit in a case that the second medium stacking unit is in an opened state and for leading the medium to the first medium stacking unit in a case that the second medium stacking unit is in a closed state.

According to this invention, an image forming apparatus has the first medium stacking unit for stacking the medium, the second medium stacking unit capable of being opened and closed with respect to the apparatus body for stacking the medium, and the guiding member arranged swingably on the apparatus body for leading the medium to the second medium stacking unit in a case that the second medium stacking unit is in the opened state and for leading the medium to the first medium stacking unit in a case that the second medium stacking unit is in the closed state.

In the above case, since the guiding member arranged swingably on the apparatus body leads the medium to the second medium stacking unit in a case that the second medium stacking unit is in the opened state and leads the medium to the first medium stacking unit in a case that the second medium stacking unit is in the closed state, for example, in a case that large normal curling occurs with the medium, the medium can be discharged to the second medium stacking unit without rendering the medium into a face down conveyance route. Consequently, no paper jamming occurs, and the medium can be discharged properly.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a perspective view showing an essential portion of a face up discharging unit according to the first embodiment of this invention;

FIG. 2 is a schematic view showing a printer according to the first embodiment of this invention;

FIG. 3 is a perspective view showing the face up discharging unit according to the first embodiment of this invention;

FIG. 4 is a perspective view showing a leading guide according to the first embodiment of this invention;

FIG. 5 is a front view showing the leading guide according to the first embodiment of this invention;

FIG. 6 is a diagram showing a relationship between a gravity center and a rotation center of the leading guide according to the first embodiment of this invention;

FIG. 7 is a diagram showing a method of mounting the leading guide according to the first embodiment of this invention;

FIG. 8 is a diagram showing a relationship between the leading guide and a face up stacker at the time of a face down printing according to the first embodiment of this invention;

FIG. 9 is a diagram showing the face up discharging unit at the time of the face down printing according to the first embodiment of this invention;

FIG. 10 is a perspective view showing the face up discharging unit at the time of a face up printing according to the first embodiment of this invention;

FIG. 11 is a conceptual view showing the face up discharging unit at the time of the face up printing according to the first embodiment of this invention;

FIG. 12 is a perspective view showing the leading guide according to the second embodiment of this invention;

FIG. 13 is a front view showing the leading guide according to the second embodiment of this invention;

FIG. 14 is a diagram showing a relationship between the gravity center and the rotation center of the leading guide according to the second embodiment of this invention;

FIG. 15 is a diagram showing a relationship between the leading guide and the face up stacker at the time of the face down printing according to the second embodiment of this invention;

FIG. 16 is a diagram showing the face up discharging unit at the time of the face down printing according to the second embodiment of this invention;

FIG. 17 is a diagram showing an essential portion of the face up discharging unit at the time of the face down printing according to the second embodiment of this invention;

FIG. 18 is a conceptual view showing the face up discharging unit at the time of the face up printing according to the second embodiment of this invention;

FIG. 19 is a conceptual view showing an essential portion of the face up discharging unit at the time of the face up printing according to the second embodiment of this invention;

FIG. 20 is a perspective view showing the face up discharging unit according to the third embodiment of this invention;

FIG. 21 is a perspective view showing an essential portion of the face up discharging unit according to the third embodiment of this invention;

FIG. 22 is a perspective view showing the leading guide according to the third embodiment of this invention;

FIG. 23 is a front view showing the leading guide according to the third embodiment of this invention;

FIG. 24 is a diagram showing a relationship between the gravity center and the rotation center of the leading guide according to the third embodiment of this invention;

FIG. 25 is a perspective view showing the face up discharging unit to which the leading guide is mounted at the time of the face up printing according to the third embodiment of this invention;

FIG. 26 is a diagram showing the face up discharging unit at the time of the face down printing according to the third embodiment of this invention;

FIG. 27 is a perspective view showing the face up discharging unit at the time of the face up printing according to the third embodiment of this invention; and

FIG. 28 is a conceptual view showing the face up discharging unit at the time of the face up printing according to the third embodiment of this invention.

### DETAILED DESCRIPTION OF THE INVENTION

Hereinafter, embodiments according to this invention will be described with reference to the figures. In this case, an image forming apparatus such as, e.g., an electrophotographic color printer will be described.

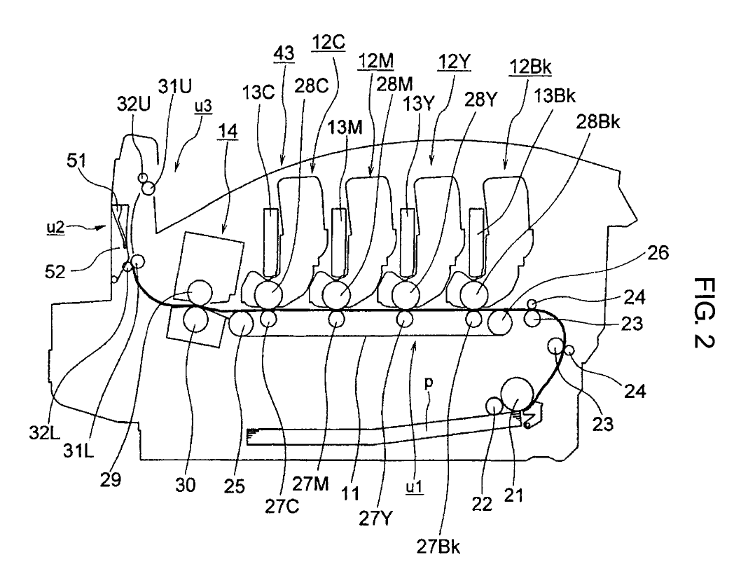

FIG. 2 is a schematic view showing a printer according to the first embodiment of this invention.

In the figure, P is paper as a medium, and an anterior end of the paper P is pushed up by a sheet receiver, not shown, in a paper feeding cassette, not shown, serving as a medium containing unit so that the paper P is appressed to a paper feeding roller 21. By driving a conveyance motor, not shown, the paper feeding roller 21 and a paper feeding sub roller 22 are rotated, and thus the paper P is fed successively from the paper feeding cassette to a conveyance route. On the conveyance route, a resister roller 23 is arranged on a downstream side relative to the paper feeding roller 21 in a conveyance direction of paper P; a pressure roller 24 is arranged opposing the resister roller 23; and the paper P is conveyed as sandwiched between the resister roller 23 and the pressure roller 24.

A conveyance belt unit u1 has a driving roller 25 driven by a belt motor, not shown, an idle roller 26, and an endless conveyance belt 11 arranged to be tensioned between the driving roller 25 and the idle roller 26 and serving as a conveyance member driven to convey the paper P. The idle roller 26 rotates in association with a movement of the conveyance belt 11 and gives tension so that the conveyance belt 11 does not come loose.

On the conveyance belt 11, ID units 12Bk, 12Y, 12M, and 12C as image forming units are arranged side by side along the conveyance direction of the paper P. At an inside of the discharging belt 11, transfer rollers 27Bk, 27Y, 27M, and 27C as transfer members giving transfer voltage are arranged respectively opposing ID units 12Bk, 12Y, 12M, and 12C.

The ID units 12Bk, 12Y, 12M, and 12C have not only photosensitive drums 28Bk, 28Y, 28M, and 28C respectively as image carriers but also charging rollers as charging devices for evenly and uniformly charging surfaces of the photosensitive drums 28Bk, 28Y, 28M, and 28C, developing units for developing images by attaching black, yellow, magenta, and cyan toners respectively as developers onto electrostatic latent images formed on the surfaces of photosensitive drums 28Bk, 28Y, 28M, and 28C, to form toner images as developer images, and cleaning blades as cleaning devices to remove toners remaining on the surfaces of the photosensitive drums 28Bk, 28Y, 28M, and 28C.

LED heads 13Bk, 13Y, 13M, and 13C as exposure devices are respectively arranged adjacent to the ID units 12Bk, 12Y, 12M and 12C and opposing the photosensitive drums 28Bk, 28Y, 28M, and 28C. The LED heads 13Bk, 13Y, 13M, and 13C irradiate the surfaces of the photosensitive drums 28Bk, 28Y, 28M, and 28C by driving LEDs, thereby forming electrostatic latent images. Furthermore, each of the transfer rollers 27Bk, 27Y, 27M, and 27C successively transfers the toner image of each color onto the paper P conveyed by the conveyance belt 11 to form a color toner image.

A fuser 14 serving as a fusing device has a fusing roller 29 rotated by a fusing motor, not shown, and a pressure roller 30 rotating in association with a movement of the fusing roller 29. The fuser 14 forms a color image by fusing the color toner image on the paper P conveyed by the conveyance belt 11.

The paper P on which the color image was formed is conveyed by a discharging roller 31L driven by the fusing motor and by a discharging roller 32L rotating in association with the discharging roller 31L. The paper P is discharged either to a face up stacker 52 via a leading guides 51 serving as guiding members or to a top cover 43 upon being conveyed by the discharging rollers 31L and 32L and further conveyed by a discharging roller 31U driven by the fusing motor and by a discharging roller 32U rotating in association with the discharging roller 31U. It is to be noted that the first medium stacking unit is composed of the top cover 43 and the second medium stacking unit is formed with the face up stacker 52.

A face up discharging unit u2 is composed of the discharging roller 31L, the discharging roller 32L, the leading guides 51, the face up stacker 52, and the like. A face down discharging unit u3 is composed of the discharging roller 31U, the discharging roller 32U, the top cover 43, and the like. Furthermore, a discharging member is composed of the discharging rollers 31L, 31U and the discharging rollers 32L, 32U.

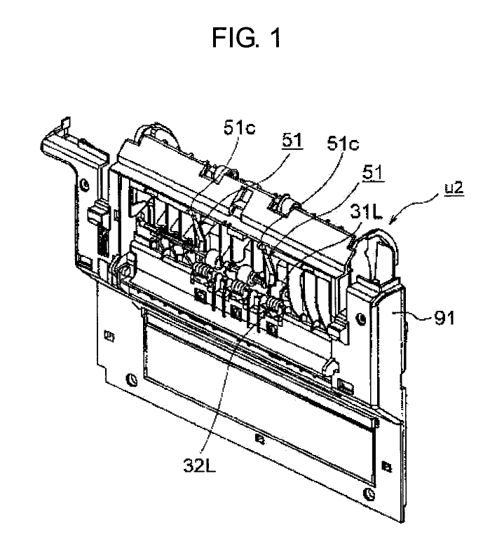

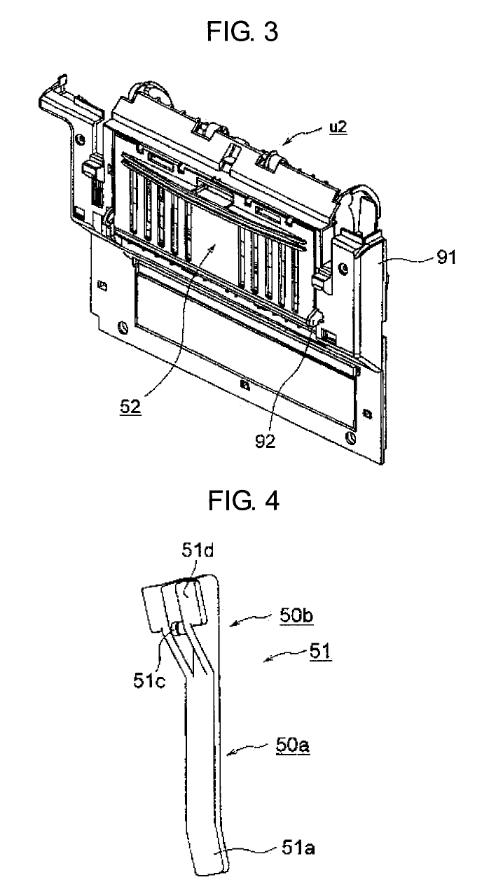

FIG. 1 is a perspective view showing an essential portion of the face up discharging unit according to the first embodiment of this invention. FIG. 3 is a perspective view showing the face up discharging unit according to the first embodiment of this invention.

In the figure, numeral u2 is the face up discharging unit; numeral 91 is the apparatus body of the printer; numerals 51 are a plurality of leading guides (i.e., a pair of leading guides in this embodiment) arranged swingably with respect to the apparatus body 91 about a rotation center 51c, the rotation center 51c being formed at an upper end thereof; numeral 52 is the face up stacker arranged pivotally about a swinging supporting portion 92 formed at a lower end thereof and capable of taking either an opened position and a closed position; numeral 31L is the discharging roller; numeral 32L is the discharging roller; and FIG. 1 shows a state where the face up stacker 52 is removed. A space between the leading guides 51 is rendered narrower than a minimum width of the paper P. Although a pair of the leading guides 51 are arranged in this embodiment, for example, in a case that three or more pieces of the leading guides are arranged, at least one of the spaces among the leading guides is rendered narrower than a minimum width of the paper P.

When the paper P is conveyed to the face down discharging unit u3 (FIG. 2), the leading guides 51 have a function of conveyance guides and are held by the face up stacker 52. Furthermore, the face up stacker 52 can be opened and closed. The face up stacker 52 has a function of the conveyance guide in the closed position when the paper P is to be discharged to the face down discharging unit u3 (hereinafter referred to as “at the time of the face down printing”) while having a function of a stacking unit for allowing the discharged paper P stacked thereon in the opened position when the paper P is to be discharged to the face up discharging unit u2 (hereinafter referred to as “at the time of the face up printing”). Each of the leading guides 51 is arranged at an interval narrower than a paper width as a medium width printable in a horizontal direction.

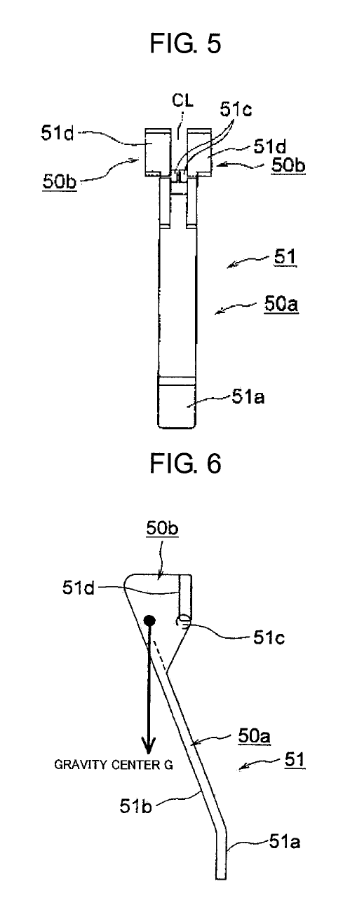

FIG. 4 is a perspective view showing the leading guide according to the first embodiment of this invention; FIG. 5 is a front view of the leading guide according to the first embodiment of this invention; and FIG. 6 is a diagram showing a relationship between a gravity center and a rotation center of the leading guide according to the first embodiment of this invention.

As shown in the figures, the leading guide 51 has a tabular guiding portion 50a in a bent shape, the guiding portion 50a being bent at a point near lower end, and a pair of attaching portions 50b in a triangular shape, the attaching portions 50b being formed at an upper end of the guiding portion 50a with a prescribed clearance CL therebetween. First and second surfaces 51a and 51b are formed on the guiding portion 51a in order to guide the paper P (FIG. 2). Furthermore, the attaching portions 50b respectively have rotation centers 51c formed opposing each other toward the clearance CL and stopper portions 51d formed projecting in a direction opposite to the clearance CL. A gravity center G of the leading guide 51 is set at a side of the face up stacker 52 with respect to the rotation center 51c on the attaching portions 50b.

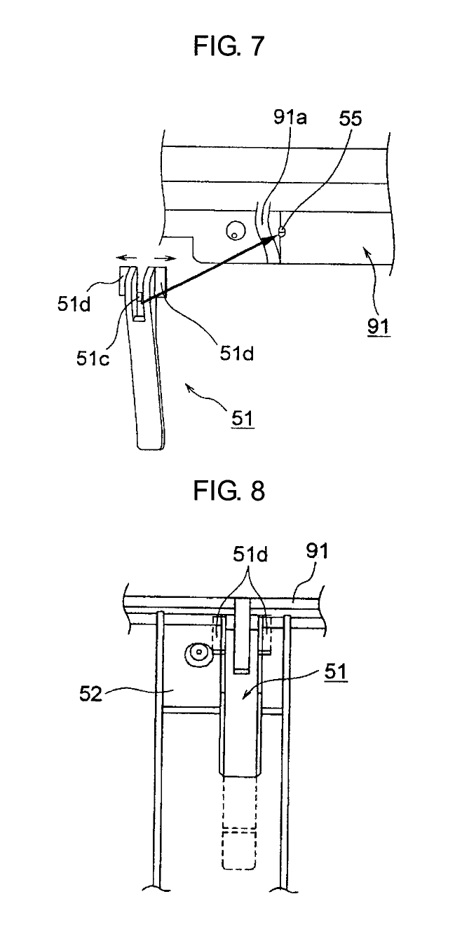

FIG. 7 is a diagram showing a method of attaching the leading guide according to the first embodiment of this invention, and FIG. 8 is a diagram showing a relationship between the leading guide and the face up stacker at the time of the face down printing according to the first embodiment of this invention.

As shown in the figures, a clearance between the rotation centers 51c is widened by pulling the both sides of the stopper portions 51d in directions indicated respectively by arrows, and then the rotation centers 51c are engaged in holes 55 previously formed on a back side of the apparatus body 91 with the stopper portions 51d replaced to the original positions, so that the leading guide 51 can be attached to the apparatus body 91. On the apparatus body 91, a bracket 91a in a triangular shape is formed as protruding, and the leading guide 51 is attached in a manner to sandwich the bracket 91a between the attaching portions 50b (FIG. 6). Numeral 52 is the face up stacker.

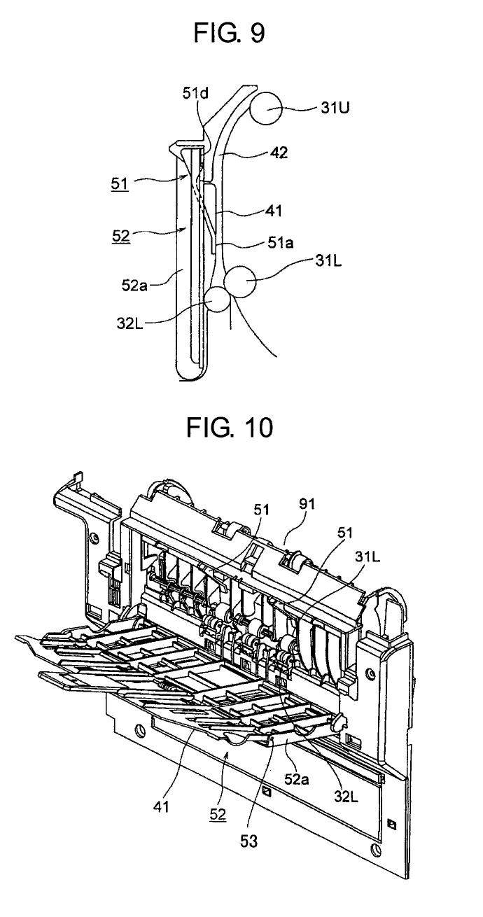

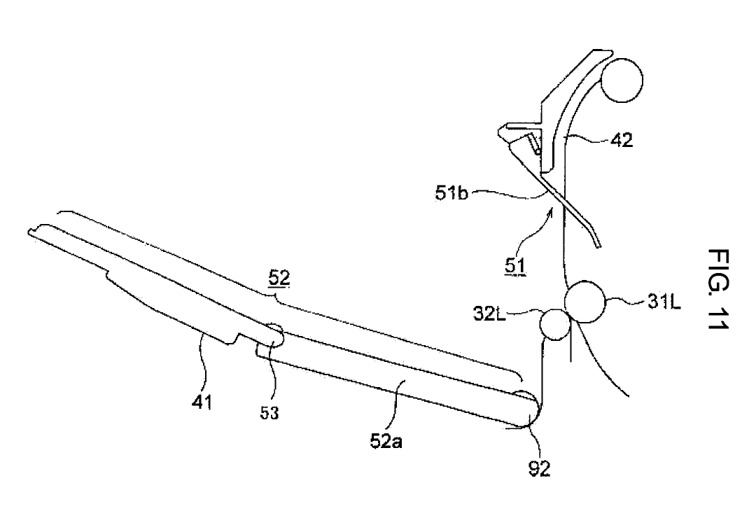

FIG. 9 is a diagram showing the face up discharging unit at the time of the face down printing according to the first embodiment of this invention; FIG. 10 is a perspective view showing the face up discharging unit at the time of the face up printing according to the first embodiment of this invention; and FIG. 11 is a conceptual view showing the face up discharging unit at the time of the face up printing according to the first embodiment of this invention.

At the time of the face down printing, as shown in FIG. 9, when the face up stacker 52 is set in the closed position, the stopper portions 51d are sandwiched between the face up stacker 52 and the apparatus body 91 so that the leading guide 51 is held in a non-swingable state. The face up stacker 52 is arranged swingably about the swinging supporting portion 92 with respect to the apparatus body 91. The face up stacker 52 has a main body 52a and a guiding portion 41 connected to the main body 52a via a hinge 53. The guiding portion 41 is folded in when the face up stacker 52 is set in the closed position.

The paper P conveyed by the discharging roller 31L and by the discharging roller 32L is guided to a face down conveyance route 42 by the guiding portion 41 of the face up stacker 52 and by a first surface 51a of the leading guide 51. Furthermore, the paper P is conveyed by a discharging roller 31U and a discharging roller 32U.

At the time of the face up printing, as shown in FIGS. 10 and 11, when the face up stacker 52 is set in the opened position, each of the leading guides 51 is rotated by its own weight, thereby being rendered in a position across the face down conveyance route 42, and thus a second surface 51b forms a face up conveyance route.

The paper P conveyed by the discharging roller 31L and by the discharging roller 32L is discharged to the face up stacker 52 along the second surface 51b of the leading guides 51 without entering into the face down conveyance route 42.

Therefore, according to the embodiment, for example, in a case that large normal curing occurs on the paper P, the paper P can be discharged to the face up stacker 52 without entering into the face down conveyance route 42. Consequently, no paper jamming occurs, and the paper P is discharged properly.

Since the leading guide 51 returns the paper P with normal curling to its original shape and gives elasticity thereto, the paper P can be stacked on the face up stacker 52 in a good condition.

In the meantime, in a case that reverse curling of the paper P occurs, the paper P is discharged without coming in contact with the leading guide 51, and thus the reverse curling is not promoted.

Since the leading guide 51 can be rotated by its own weight, an urging member and the like are not required. Thus, a cost for the printer is reduced.

Although the leading guides 51 automatically rotates when the face up stacker 52 is either opened or closed according to the embodiment of this invention, the leading guides 51 can also be manually rotated by an operator. Although the leading guides 51 are arranged at the two locations according to the embodiment of this invention, the leading guide 51 can be arranged at one location in the center.

In the meantime, according to the embodiment of this invention, in a case that elastic paper P such as, e.g., thick paper and a postcard is used, the leading guide 51 cannot be surely arranged at a location across the face down conveyance route 42. In a case that the rotation centers 51c become bumpy, the leading guides 51 cannot be switched stably over a protracted period of time.

Hereinafter the second embodiment will be described. It is to be noted that the substantially same structures as those of the first embodiment are assigned with the same reference numbers respectively so that those duplicated descriptions are omitted, and the advantageous effect of the first embodiment is applied to the advantageous effects of the second embodiment produced because of the substantially same structures as those of the first embodiment. Since a structure of a printer according to the second embodiment of this invention is the same as that according to the first embodiment of this invention, it will be described with reference to FIG. 2.

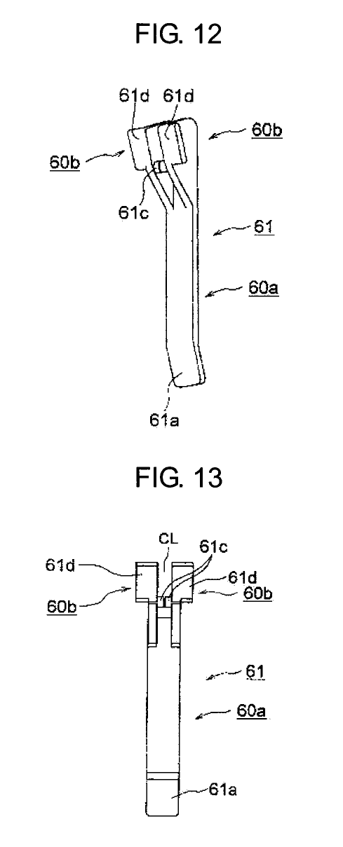

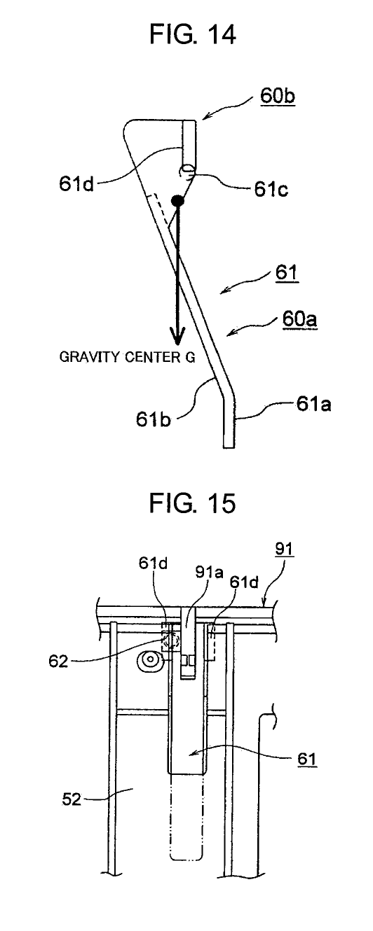

FIG. 12 is a perspective view showing the leading guide according to the second embodiment of this invention; FIG. 13 is a front view showing the leading guide according to the second embodiment of this invention; FIG. 14 is a diagram showing a relationship between the gravity center and the rotation center of the leading guide according to the second embodiment of this invention; FIG. 15 is a diagram showing a relationship between the leading guide and the face up stacker at the time of the face down printing according to the second embodiment of this invention.

As shown in the figure, a leading guide 61 serving as a leading member has a tabular guiding portion 60a in a bent shape, the leading member 61 being bent at a point near lower end, and a pair of attaching portions 60b in a triangular shape, the attaching portions 60b being formed at an upper end of thereof with a prescribed clearance CL therebetween. First and second surfaces 61a and 61b are formed on the guiding portions 60a in order to guide the paper P (FIG. 2) as the medium. The attaching portions 60b respectively have rotation centers 61c formed opposing one another toward the clearance CL and stopper portions 61d formed projecting to a direction opposite to the clearance CL. A gravity center G of the leading guide 61 is set at a side opposite to the face up stacker 52 with respect to a rotation center 61c on the attaching portions 60b.

In a similar fashion to the first embodiment of this invention, a clearance between the rotation centers 61c is widened by pulling respectively the both sides of the rotation centers 61d, and then the rotations centers 61c are engaged in holes 55 (FIG. 7) previously formed on a back side of the apparatus body 91 with the stopping portions 61d replaced to the original positions, so that the leading guide 61 can be attached to the apparatus body 91. On the apparatus body 91, a bracket 91a in a triangular shape is formed as protruding, and the leading guide 61 is attached in a manner to sandwich the bracket 91a between the attaching portions 60b.

A coil spring 62 as an urging member is arranged between one of the attaching portions 60b and the apparatus body 91. The coil spring 62 urges the leading guide 61 in a direction of the face up stacker 52. In a case that the face up stacker 52 is set in the closed state, an amount of compression of the coil spring 62 is larger than that in a case that the face up stacker is set in the opened state.

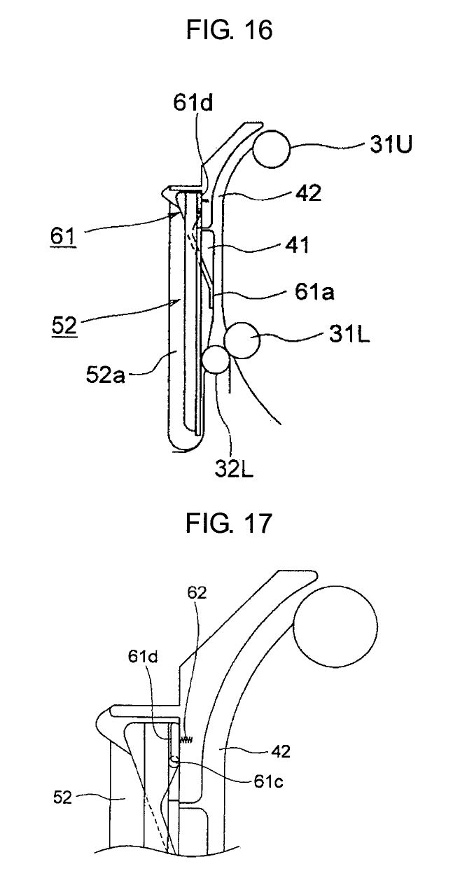

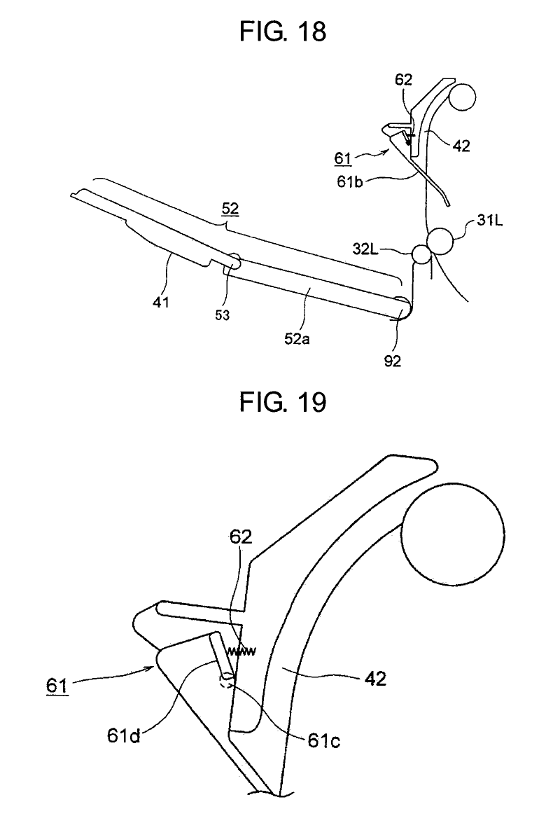

FIG. 16 is a diagram showing the face up discharging unit at the time of the face down printing according to the second embodiment of this invention; FIG. 17 is a drawing showing an essential portion of the face up discharging unit at the time of the face down printing according to the second embodiment of this invention; FIG. 18 is a conceptual view of the face up discharging unit at the time of the face up printing according to the second embodiment of this invention; and FIG. 19 is a conceptual view showing an essential portion of the face up discharging unit at the time of the face up printing according to the second embodiment of this invention.

At the time of the face down printing, as shown in FIGS. 16 and 17, when the face up stacker 52 is set in the closed position, the stopper portions 61d, opposing the urging force of the coil spring 62, is sandwiched between the face up stacker 52 and the apparatus body 91 (FIG. 15), and thereby the leading guide 61 is held in a non-swingable state. It is to be noted that the face up stacker 52 is arranged pivotally about the swinging supporting portion 92 relative to the apparatus body 91, and the face up stacker 52 has the main body 52a and the guiding portion 41 connected to the main body 52a via the hinge 53. The guiding portion 41 is folded in when the face up stacker 52 is set in the closed position.

The paper P (FIG. 2) is conveyed by the discharging roller 31L and by the discharging roller 32L, and the paper P is guided to the face down conveyance route 42 by the guiding portion 41 of the face up stacker 52 and by the first surface 61a of the leading guide 61. Furthermore, the paper P is conveyed by the discharging roller 31U and by the discharging roller 32U.

At the time of the face up printing, as shown in a FIG. 18, when the face up stacker 52 is set in the opened position, as shown in FIG. 19, the leading guide 61 rotated by an urging force of the coil spring 62 is placed at a position across the face down conveyance route 42, and thus the second surface 61b forms the face up conveyance route.

The paper P conveyed by the discharging roller 31L and by the discharging roller 32L is discharged to the face up stacker 52 along the second surface 61b of the leading guide 61 without entering into the face down conveyance route 42.

As described above, according to this embodiment, since the leading guide 61 is rotated by an urging force of the coil spring 62, even in a case that stiff paper P such as, e.g., thick paper and a postcard is used, the guiding unit 61 is surely placed at a location across the face down conveyance route 42. Thereby, the face up conveyance route is stably formed with the second surface 61b. Furthermore, even in a case that the rotation centers 61c become bumpy, the leading guide 61 can be switched stably over a protracted period of time.

Herein, the third embodiment of this invention capable of stably switching whether the face down conveyance route 42 or the face up conveyance route without forming a hole 55 (FIG. 7) for arranging a rotation center will be described. It is to be noted that the substantially same structures as those of the first or the second embodiments are assigned with the same reference numbers respectively, and the advantageous effect of the previous embodiments are applied to the advantageous effects of the embodiment produced because of the substantially same structures as those of the previous embodiments. Since a structure of a printer according to the embodiment of this invention is the same as that according to the first embodiment of this invention, it will described with reference to FIG. 2.

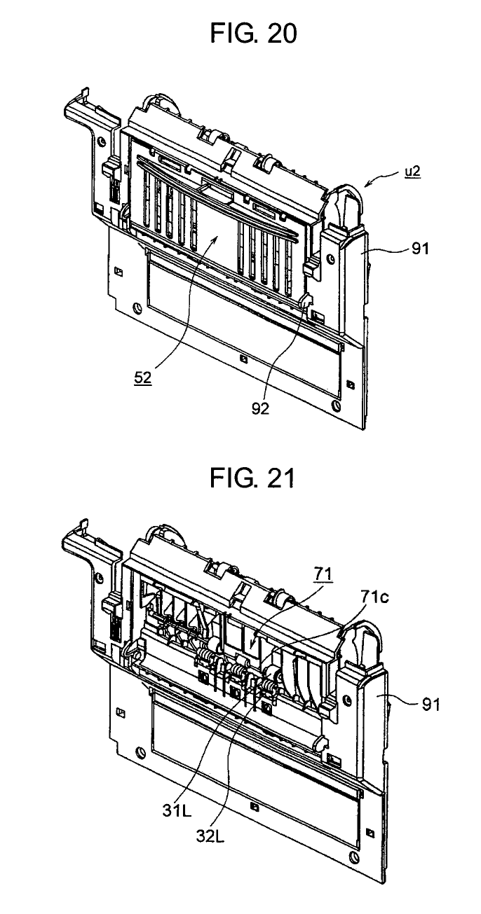

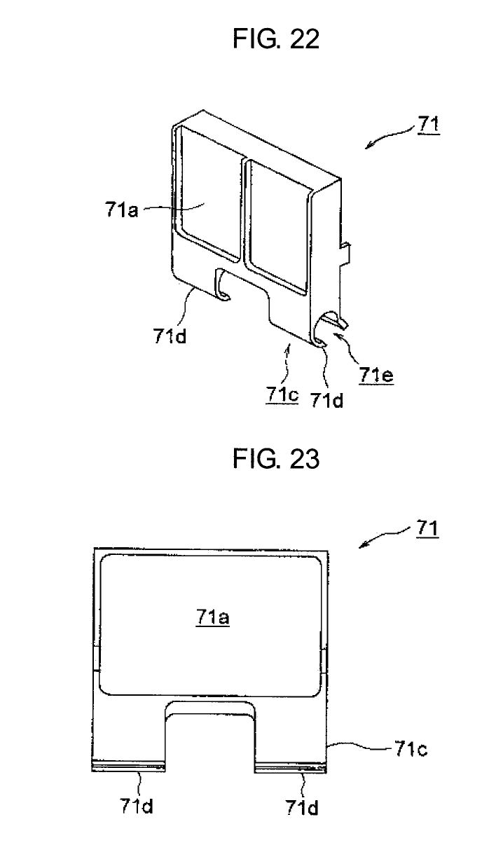

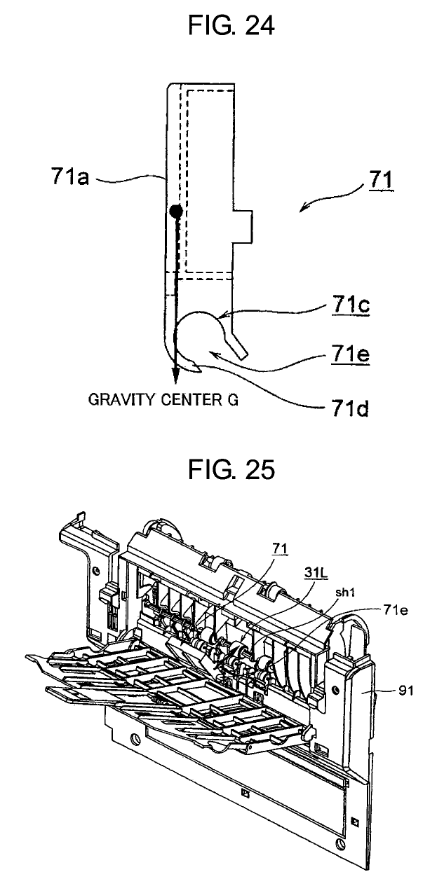

FIG. 20 is a perspective view showing the face up discharging unit according to the third embodiment of this invention; FIG. 21 is a perspective view showing an essential portion of the face up discharging unit according to the third embodiment of this invention; FIG. 22 is a perspective view showing the leading guide according to the third embodiment of this invention; FIG. 23 is a front view of the leading guide according to the third embodiment of this invention; FIG. 24 is a diagram showing a relationship between the gravity center and a rotation center of the leading guide; and FIG. 25 is a perspective view showing the face up discharging unit with the leading guide attached at the time of the face up printing according to the third embodiment of this invention.

In the figure, u2 is the face up discharging unit; numeral 91 is the apparatus body of the printer; numeral 71 is a leading guide serving as the guiding member arranged swingably with respect to the apparatus body about a rotation center 71c formed at a lower end thereof; numeral 52 is the face up stacker arranged pivotally about the swinging supporting portion 92 formed at a lower end and capable of taking either an opened position and a closed position; and FIG. 21 is showing a state that the face up stacker 52 is removed. The leading guide 71 has a leading surface 71a on a side facing the face up stacker 52. It is to be noted that the rotation center 71c is arranged coaxially to the discharging roller 31L and arranged in a center of an axis of the discharging roller 31L.

The rotation center 71c is formed with a cutout 71e which is formed by cutting some portion of the leading guide 71, so that the leading guide 71 can be attached coaxially to the discharging roller 31L. An end portion 71d of the cutout 71e restricts a rotation angle of the leading guide 71 to a specified amount. It is to be noted that a gravity center G of the leading guide 71 is set at a side of the face up stacker 52 with respect to the rotation center 71c.

As shown in FIG. 25, the leading guide 71 can be attached by fitting the cutout 71e about an axis sh1 of the discharging roller 31L.

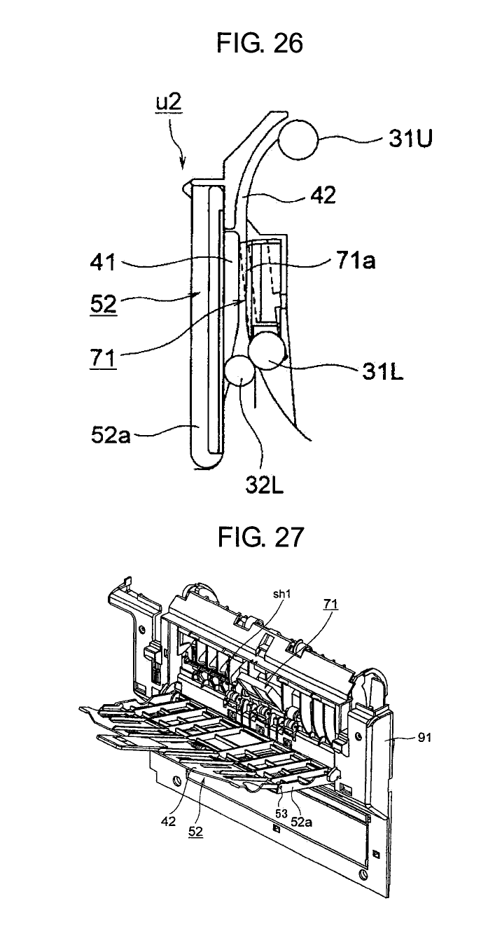

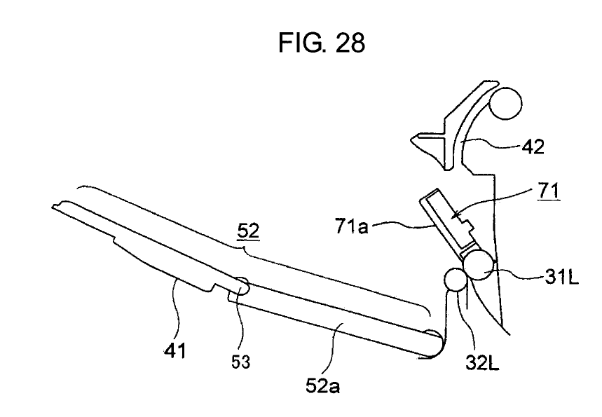

FIG. 26 is a diagram showing the face up discharging unit at the time of the face down printing according to the third embodiment of this invention; FIG. 27 is a perspective view showing the face up discharging unit at the time of the face up printing according to the third embodiment of this invention; and FIG. 28 is a conceptual view showing the face up discharging unit at the time of the face up printing according to the third embodiment of this invention.

At the time of the face down printing, as shown in FIG. 26, when the face up stacker 52 is set in the closed position, the leading guide 71 falls until coming in contact with the guiding portion 41 and thereby covers the face down conveyance route 42, as indicated by a dashed line.

However, in a state described above, an angle made by a direction of the gravity center G and the face down conveyance route 42 is so small that the leading guide 71 is rotated, as indicated by a full line, as the paper P (FIG. 2) as the medium is conveyed. Thereby, neither a scar, a burr, nor a scratch is occurred at an anterior end of the paper P.

In the meantime, at the time of the face up printing, as shown in FIGS. 27 and 28, when the face up stacker 52 is set in the opened position, the leading guide 71 rotated by its own weight about an axis sh1 is placed in a position across the face down conveyance route 42 and stopped at a rotation restriction position. Thereby, the leading surface 71a forms the face up conveyance route.

Therefore, according to the embodiment, for example, in a case that large normal curling of the paper P occurs, the paper P is discharged to the face up stacker 52 without being rendered into the face down conveyance route 42. Consequently, no paper jamming occurs, and the paper P is discharged properly.

Furthermore, since the leading guide 71 returns the paper P with the normal curling to its original shape and gives elasticity thereto, the paper P is stacked on the face up stacker 52 in a good condition.

In the meantime, in a case that reverse curling occurs with the paper P, the paper P can be discharged without coming in contact with the leading guide 71, and thereby the reverse curling is not promoted.

Furthermore, since the leading guide 71 can be rotated by its own weight, an urging member and the like are not required. Consequently, a cost for the printer is reduced.

Furthermore, since the hole 55 for arranging the rotation center is not required to be formed, a switching operation between the face down conveyance route 42 and the face up conveyance route is stabilized.

Although the leading guide 71 is rotated automatically when the face up stacker 52 is opened or closed according to the embodiment, an operator can also manually rotate the leading guide 71. Furthermore, a spring as an urging member may urge the leading guide 71 in a rotation direction.

Although the leading guide 71 is arranged at one location according to the embodiment, the leading guides 71 can be arranged at a plurality of locations with spaces among the leading guides 71 being rendered narrower than a minimum width of the paper P.

Although an electrophotographic printer is described in this invention, this invention is applicable to an inkjet printer, thermal printer, a dot impact printer and the like. Although the printer having two discharging units has been described herein, this invention is also applicable to a printer having a plurality of discharging units having a sorting function and to a one having post process functions such as, e.g., a punching function, a scission function, a cutting function, and a binding function and having a plurality of discharging routes.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An image forming apparatus comprising:
an apparatus body;
a first medium stacking unit for stacking a medium;
a second medium stacking unit arranged capable of being opened and closed with respect to said apparatus body for stacking the medium; and
a guiding member arranged swingably on said apparatus body, said guiding member guiding the medium to said second medium stacking unit where said second medium stacking unit is in an opened state and to said first medium stacking unit where said second medium stacking unit is in a closed state.

2. The image forming apparatus according to claim 1, wherein said guiding member includes first and second surfaces, and wherein said guiding member guides the medium to said first medium stacking unit with said first surface and guides the medium to said second medium stacking unit with said second surface.

3. The image forming apparatus according to claim 2, wherein when said second medium stacking unit is in the opened state, said guiding member blocks a medium conveyance route to said first medium stacking unit and contacts the medium conveyed to said second surface.

4. The image forming apparatus according to claim 2, wherein when said second medium stacking unit is in the closed state, said guiding member clears a medium conveyance route to said first medium stacking unit and leads the conveyed medium to said first medium stacking unit with said first surface.

5. The image forming apparatus according to claim 1, wherein said guiding member includes an attaching portion and a medium guiding portion extended from said attaching portion, and wherein said attaching portion includes a rotation center serving as a swinging center when attached to said apparatus body.

6. The image forming apparatus according to claim 5, wherein said guiding member further includes a stopper preventing said guiding member from swinging when said second medium stacking unit is in the closed state.

7. The image forming apparatus according to claim 5, wherein said guiding member includes a gravity center arranged with respect to said rotation center of said guiding member to render said attaching portion move toward said second medium stacking unit.

8. The image forming apparatus according to claim 5, wherein said guiding member includes a gravity center arranged with respect to said rotation center of said guiding member to render said attaching portion move toward an opposite side of said second medium stacking unit.

9. The image forming apparatus according to claim 5, wherein said guiding member includes an urging member urging said attaching portion of said guiding member to a direction of said second medium stacking unit.

10. The image forming apparatus according to claim 1, wherein said guiding member is arranged in a plural number, and wherein at least one of spaces among guiding members is set narrower than a minimum width of the medium to be stacked.

11. The image forming apparatus according to claim 1 and further comprising a conveyance member supported rotatably by said apparatus body for conveying the medium, and wherein a rotation center of said guiding member is arranged coaxially to said conveyance member.

12. The image forming apparatus according to claim 11, wherein said conveyance member includes an axis and a conveyance roller attached to said axis, and wherein said guiding member includes an attaching portion rotatably attached to said axis.

13. The image forming apparatus according to claim 1, wherein said apparatus body includes an image forming unit for forming an image onto the medium and a conveyance member for conveying the medium on which the image is formed to said first or said second medium stacking unit.

14. The image forming apparatus according to claim 13, wherein said first medium stacking unit is arranged at an upper side of said apparatus body, and wherein said second medium stacking unit is formed at a side of said apparatus body.

15. The image forming apparatus according to claim 14, wherein said first medium stacking unit stacks the medium with an image formed side down, and wherein said second medium stacking unit stacks the medium with an image formed side up.
